(19) United States
(12) Patent Application Publication
(10) Pub. No.: US 2016/0310769 A1
(43) Pub. Date: Oct. 27, 2016

(54) ACTIVE VENTING SYSTEM AND DEVICES INCORPORATING ACTIVE VENTING SYSTEM

(71) Applicant: INNOSPARKS PTE LTD, Singapore (SG)

(72) Inventors: Ee Ho TANG, Singapore (SG); Kwok Jiang SAK, Singapore (SG); Wei Liang Jerome LEE, Singapore (SG)

(21) Appl. No.: 15/101,157

(22) PCT Filed: Oct. 24, 2014
(86) PCT No.: PCT/SG2014/000498

§ 371 Date: Jun. 2, 2016

Related U.S. Application Data
(60) Provisional application No. 61/911,995, filed on Dec. 4, 2013.

(30) Foreign Application Priority Data
Dec. 31, 2013 (SG) 2013097191

(51) Int. Cl. A62B 18/00; A62B 23/02; A62B 18/08; A62B 18/02

(52) U.S. Cl. CPC A62B 18/006; A62B 18/02; A62B 23/025; A62B 18/08

(57) ABSTRACT

An active venting system for venting air from devices covering mouth and nose, said active venting system comprises: a power source; a blower coupled to the power source; and an electronic device or a printed circuit board coupled to the blower, wherein the blower is turned on or off by the electronic device or printed circuit board to vent exhaled or dead air from the respirator body. Also, provided are respiratory devices comprising the active venting system.

### TECHNICAL FIELD

The present disclosure relates generally to an active venting system (AVS) for use in protective gears and respiratory devices such as masks, helmets, covering nose and face of wearer. More particularly, present invention refers to a respiratory device with an active venting system to effectively remove exhaled air in every breathing cycle.

### BACKGROUND

Protective gears and respiratory devices such as masks, helmets, etc., that covers nose and face of a wearer need venting systems to remove warm and humid exhaled air inside them during its operation. The venting system can be with or without forced ventilation.

US 20110083255 discloses a venting system for a sports helmet with air venting openings wherein at least some of the venting openings have covers that at least partially cover the venting openings. By tilting about an axis of rotation, the covers partially or completely release the venting openings. Upon actuation of the cover, one end of the cover is lifted above the surrounding helmet surface while the other end of the cover is lowered below the level of the surrounding helmet surface. Thus, the air inside the sports helmet is vented by actuation of the cover by the user and not by the forced ventilation.

N95 masks and respirators are used as protective gears against air pollutants such as haze and influenza. Commercially available products without forced ventilation are classified into two main categories: single-use disposable respirators and reusable respirators with detachable filter cartridges. These products without forced ventilation often come with a one-way integrated valve (passive valves) to allow the exhaled air to escape. However, the efficacy of these passive valves in removing the warm and humid exhaled air is highly dependent on breathing depth and pressure.

Often, the exhaled air is forced to exit through the filters due to the limited window of the one-way valve. Moisture in the warm exhaled air condenses as it flows through the cold filters and blocks the air channels within the filters partially or completely. The reduction in the size of the air channels directly increases air resistance which causes breathing difficulties. In addition, lack of a proper exhalation pathway causes the hot and humid exhaled air to circulate within the respirator body thus, creating discomfort to the user.

To counter this problem, respirators with forced ventilation or air supply powered by fans and/or blowers are available. These devices are designed to supply significant airflow of up to 800 L/min to cater to the breathing needs of an individual. These products are typically bulky and require significant power supply to maintain a prolong airflow and pressure. The power supply is usually external and not part of the respirator body to meet the high airflow rates. These products are therefore, not suitable for daily usage of general public.

Therefore, an active venting system is needed which when incorporated into respiratory device or protective gears, can be used comfortably for prolong usage and is suitable for general public. Further, it is required that such device should minimize facial contact of the hot and humid exhaled air which causes discomfort to a wearer and have an effective means of exhausting heat and humidity in each exhalation cycle.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

It is, therefore, an aim of the disclosed embodiments to provide for an active venting system for venting air from devices covering mouth and nose, said active venting system comprises: a power source; a blower coupled to the power source; and an electronic device or a printed circuit board coupled to the blower, wherein the blower is turned on or off by the electronic device or printed circuit board to vent the exhaled air from the respirator body.

It is, therefore, an aim of the disclosed embodiments to provide the active venting wherein the blower is a micro-fan.

It is, therefore, an aim of the disclosed embodiments to provide for the active venting system, wherein the electronic device or the printed circuit board triggers suitable control signals for the blower to regulate the speed and amount of airflow.

It is, therefore, an aim of the disclosed embodiments to provide for the active venting system, wherein the active venting system remains turned on throughout the period of use.

It is, therefore, an aim of the disclosed embodiments to provide for the active venting system, wherein the active venting system is turned off manually after use.

It is, therefore, an aim of the disclosed embodiments to provide for the active venting system, wherein the power source is a detachable and chargeable power source.

It is, therefore, an aim of the disclosed embodiments to provide for the active venting system, wherein the power source is supplied by means of an electrical wire or a cable to the electrical mains.

It is, therefore, an aim of the disclosed embodiments to provide for the active venting system, wherein the power source can be recharged via a USB-micro cable to a power bank while the active venting system is still operating.

It is, therefore, an aim of the disclosed embodiments to provide for the active venting system, wherein the power source can be charged while the active venting system is in use.

It is, therefore, an aim of the disclosed embodiments to provide for a respiratory device comprising: a respirator body which covers face and mouth of a wearer to form a relatively closed area sealed from ambient air; at least one first filter integrally disposed in the respirator body for filtering inhaled air; and at least one active venting system functionally coupled to the respirator body wherein the active venting system operates to vent air from the respirator body, wherein the active venting system comprises: a power source; a blower coupled to the power source; and an electronic device or a printed circuit board coupled to the blower, wherein the blower is turned on or off by the electronic device or printed circuit board to vent the exhaled air from the respirator body.

It is, therefore, an aim of the disclosed embodiments to provide for the respiratory device, further comprising at least one air guide positioned at around the active venting system and surrounding the nose and mouth region of wearer to channel and separate the exhaled air and the inhaled air.

It is, therefore, an aim of the disclosed embodiments to provide for the respiratory device, wherein the air guide is positioned at an angle inclined with respect to an ergonomic facial profile to remove the excess exhaled air.

It is, therefore, an aim of the disclosed embodiments to provide for the respiratory device, further comprising at least one gap between the air guide and the base of the respirator body to allow the excess exhaled air to escape in case the excess exhaled air is not vented through the active venting system.

It is, therefore, an aim of the disclosed embodiments to provide for the respiratory device, wherein the active venting system is attached to a one way control valve with a membrane to prevent the ambient air from entering through the blower inlet or outlet into the respirator body at all times.

It is, therefore, an aim of the disclosed embodiments to provide for the respiratory device, wherein the one way control valve with the membrane is attached either to an inlet or outlet of the blower.

It is, therefore, an aim of the disclosed embodiments to provide for the respiratory device, wherein the active venting system is attached to a second filter to prevent ambient air from entering the respirator body.

It is, therefore, an aim of the disclosed embodiments to provide for the respiratory device, wherein a second filter is attached either to the inlet or outlet of the blower.

It is, therefore, an aim of the disclosed embodiments to provide for the respiratory device, wherein the active venting system is attached to a latch to prevent the ambient air from entering the respirator body.

It is, therefore, an aim of the disclosed embodiments to provide for the respiratory device, wherein the latch is attached either to the inlet or outlet of the blower.

It is, therefore, an aim of the disclosed embodiments to provide for the respiratory device, wherein the latch is embedded with a sensor that automatically closes when the power of the active venting system runs out.

It is, therefore, an aim of the disclosed embodiments to provide for the respiratory device, wherein the latch is manually closed by user to block the blower opening.

It is, therefore, an aim of the disclosed embodiments to provide for the respiratory device, wherein the respirator body, the active venting system and the air guide are together collapsible into a pocket size.

It is, therefore, an aim of the disclosed embodiments to provide for the respiratory device, wherein the respirator body is disposable or reusable.

It is, therefore, an aim of the disclosed embodiments to provide for the respiratory device, wherein the respirator body is an air filtering respirator covering face of wearer partially or fully.

It is, therefore, an aim of the disclosed embodiments to provide for the respiratory device, wherein the respirator body is an air purifying respirator.

It is, therefore, an aim of the disclosed embodiments to provide for the respiratory device, wherein the respirator body is an escape hood.

It is, therefore, one another aim of the disclosed embodiments to provide for the respiratory device that is particularly lightweight, compact and cheap to produce and utilize ultra low power micro blowers.

Other aspects and advantages of the invention will become apparent from the following detail description, taken in conjunction with the accompanying drawings, illustrating by way of example the principles of the invention.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Wherever possible, like elements have been indicated by identical numbers.

FIGS. 1A-1B are exemplary illustrations of a side view of a respiratory device;

FIG. 2 is an exemplary illustration of a side view of the respiratory device of FIG. 1 showing the direction of air flow during an exhalation phase;

FIG. 3 is an exemplary illustration of a top perspective view of the respiratory device with the active venting system, air guide and filter;

FIG. 4 is an exemplary illustration of a perspective view of the air guide within the respiratory device;

FIG. 5 is an exemplary illustration of a perspective view of active venting system;

FIG. 6 is an exemplary illustration of a top perspective view of the respiratory device showing establishment of a hot air zone during exhalation;

FIG. 7 is an exemplary illustration of a top perspective view of the respiratory device showing establishment of a cool air zone during inhalation;

FIG. 8 is an exemplary illustration of a top perspective view of the respiratory device showing an embodiment of the blower with a filter;

FIG. 9 is an exemplary illustration of a side view of another embodiment of the blower with a one way control valve; and

FIG. 10 is an exemplary illustration of a side view of another embodiment of the active venting system attached to a latch.

### DETAILED DESCRIPTION OF ILLUSTRATIVE EMBODIMENTS

The particular configurations discussed in these non-limiting examples can be varied and are cited merely to illustrate at least one embodiment and are not intended to limit the scope thereof.

Present invention relates to an active venting system comprising a power source; a blower coupled to the power source; and an electronic device or a printed circuit board coupled to the blower, wherein the blower is turned on or off by the electronic device or printed circuit board to vent the exhaled air from the respirator body.

When the respirator body is worn, the exhalation jet is blocked, and the air gets recirculated, resulting in increased heat, moisture and carbon dioxide within the respirator body. The active venting system of present invention solves this problem by mimicking the natural way of breathing. The active venting system has sufficient power to vent out the exhalation, up to 1 m away. Thus the expired air is prevented from being recirculated within the respirator body.

The active venting system of instant invention not only removes the heat and moisture, but also removes the carbon dioxide. The active venting system can be adapted into all sort of protective gears such as helmets. The active venting system can also be adapted onto an escape hood. This is usually used for emergency situations, and covers the whole head or into any respiratory device. The respiratory device has a folding mechanism for easy storage and portability.

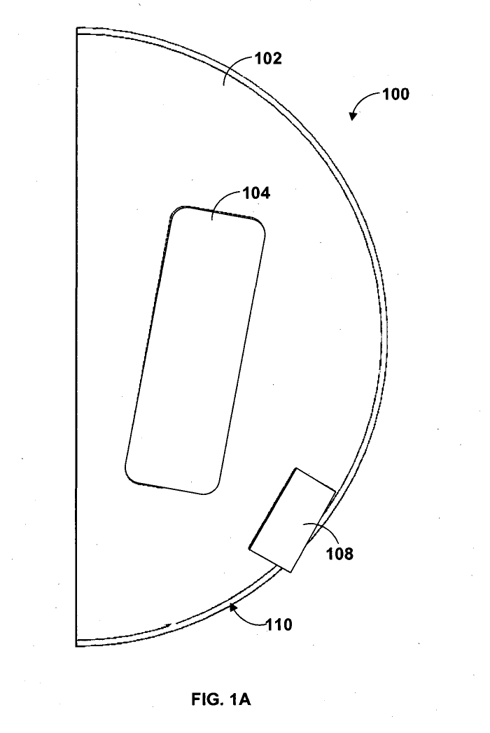

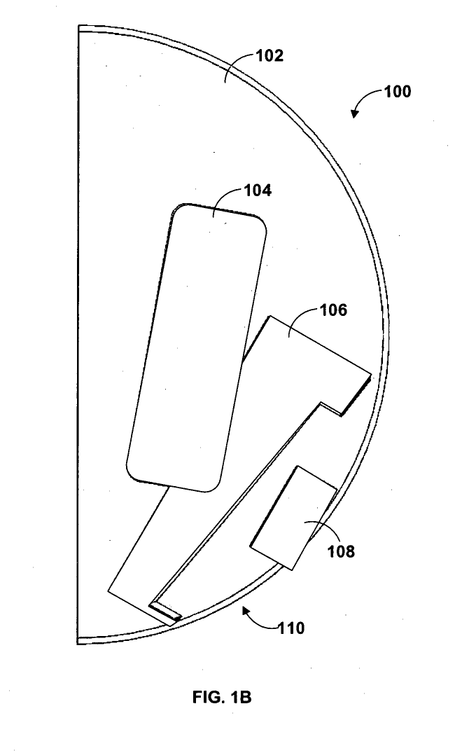

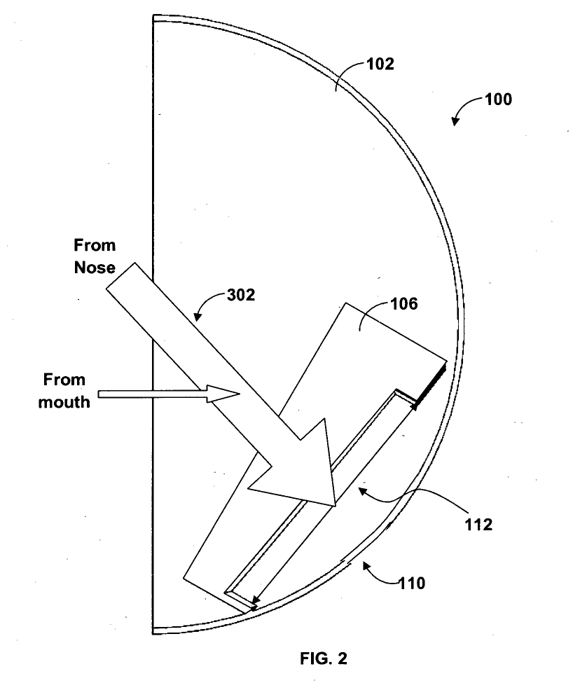

One embodiment of a respiratory device 100 depicted in FIG. 1A shows a side view of the respiratory device 100. The respiratory device 100 comprises of a respirator body 102 with one or more filters 104 and an active venting system 108. FIG. 1B illustrates a side view of a respiratory device 100 in accordance with another embodiment of the present invention, wherein the respiratory device 100 further comprises of an air guide 106. The side views of the respiratory device 100 depicted in FIGS. 1A-1B show only one filter 104. The filter 104 is integrally disposed on surface of the respirator body 102 so as to filter the inhaled air that passes through the respirator body 102. The filter 104 can be, for example, disposable or replaceable air filters and made of without limitation, paper, foam or woven fiberglass. The filter 104 may have numerous perforations through which the air passes and is filtered before it enters the respirator body 102. In the depicted embodiment, two filters 104, a single air guide 106 and active venting system 108 are provided with the respirator body 102, however, it is possible to apply the teachings of the invention with multiple such elements. It should be noted that the FIGS. 2-10 are the illustrations of various views of FIG. 1B.

As shown in FIGS. 1B, 2 and 4, the air guide 106 is positioned near a base 110 of the respirator body 102 to channel the exhaled air from the nostrils and separate the exhaled air from the inhaled air around the nostrils region. As an example, the air guide 106 is circular in shape in the form of a ring and made of for example, silicone or a flexible polymer. The air guide 106 is attached to the inner side of the respirator body 102 via molding or heat joining.

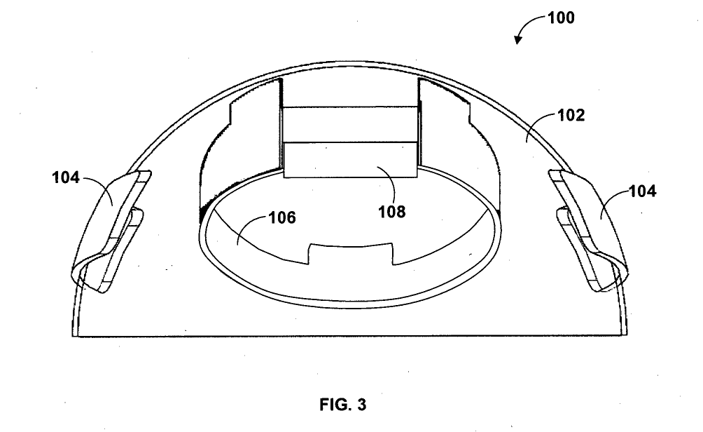

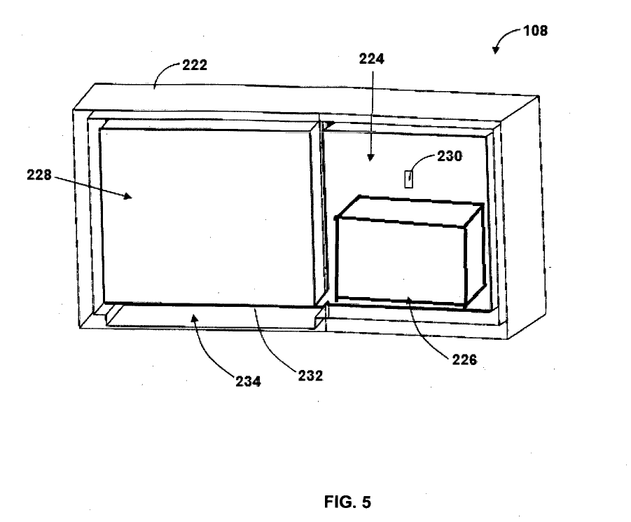

In the depicted embodiment as shown in FIGS. 1A-1B and 3, the active venting system 108 is also positioned near the base 110 of the respirator body 102 such that the active venting system 108 is within the circumference of the air guide 106. The active venting system 108 is affixed to the internal surface of the respirator body 102 and is used to remove the exhaled air from the respiratory device 100. The positioning of the active venting system 108 along with the air guide 106 facilitates removal of the exhaled air during an exhalation cycle. The active venting system 108 may remain turned on throughout its operation, or it can be timed to operate only during the exhalation cycle. In the latter case, the active venting system 108 is activated by an embedded sensor. The speed and amount of air flow may be regulated by controlling a micro blower (explained in FIG. 5) provided in the active venting system 108 using suitable control signals. The filter 104, air guide 106 and active venting system 108 are positioned to create separate air zones such that inhaled air flows through a region separate from the exhaled air and the inhaled air does not mix with the exhaled air.

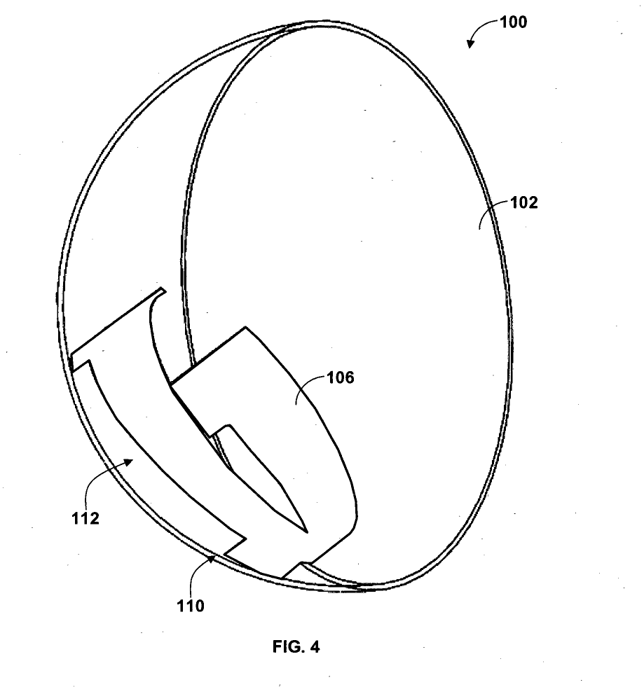

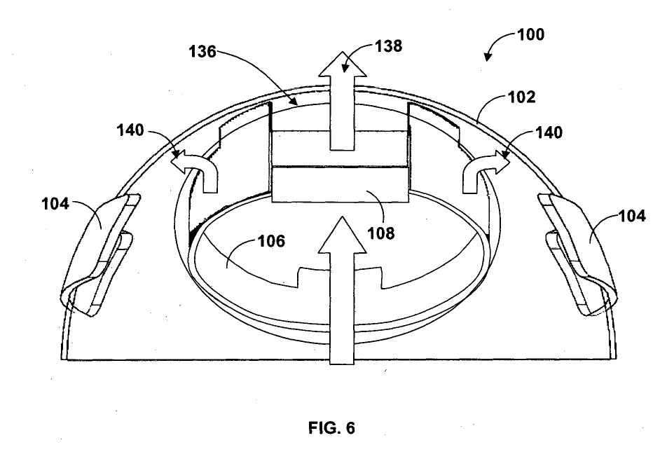

FIG. 3 illustrates a top perspective view of the respiratory device 100. The positioning of the filters 104, air guide 106 and active venting system 108 is shown in the respirator body 102. In an embodiment, the air guide 106 is positioned just below the nostrils such that the exhaled air falls directly in the space circumscribed by the air guide 106. Due to this positioning, the air guide 106 channels the exhaled air into the active venting system 108 effectively (arrow 302 shown in FIG. 2), and prevents the warm exhaled air to be directed to other parts of the respirator body 102. Hence, the air guide 106 creates a segregation of a warm air zone along the exhalation stream from the rest of the respirator body 102 (further described in FIG. 6). The exhaled air is then removed by the active venting system 108. In addition, gaps 112 (shown in FIGS. 2 and 4) are provided between the air guide 106 and the respirator body 102 for the exhaled air to escape in case the speed of the active venting system 108 is not fast enough. The gaps 112 also allow some warm exhaled air to tentatively escape along the sides of the respirator body 102, instead of reflecting back to the face after hitting the surface of the respirator body 102.

Thus, during an inhalation cycle, the ambient air from outside the respirator body 102 flows through the air filters 104 into the relative closed area within the respirator body 102. The internal air guide 106 and active venting system 108 effectively remove exhaled air during each exhaling cycle which is typically hot and humid.

Referring to FIG. 4, a perspective view of the respiratory device 100 showing air guide 106 with gaps 112 is disclosed. The air guide 106 is positioned near the base 110 of the respirator body 102 such that one or more gaps 112 are provided between the respirator body 102 and the air guide 106. The gaps 112 redirect air to other areas of the respirator body 102 during an exhalation cycle. The air guide 106 allows excess warm air to flow along the surface of the respirator body 102, if it is not rapidly vented. The air guide 106 creates a warm air zone, segregated from the rest of the respirator body 102 and skin. It should be noted that the air guide 106 is not in contact with the face and may be angled within the respirator body to capture maximum exhaled air. This angled air guide 106 forms a channel for the exhaled air from a wearer's mouth and nose into the active venting system 108.

One embodiment of the active venting system has been disclosed in FIG. 5 of the invention. The active venting system 108 has a housing 222 which houses an electronic device or a printed circuit board 224, a power source 226, a blower 228, and optionally, a sensor 230. It is to be noted that other placements of the various components of the active venting system 108 are possible and are within the scope of the present invention. The electronic device 224 may be a processing unit that controls the functioning of various components of the active venting system 108. Alternately, the electronic device 224 may include batteries and circuits only for embodiments where the blower 228 is turned on all the time. The electronic device 224 is coupled to the power source 226, the blower 228, and the sensor 230. The blower 228 is operated by the power source 226 for example, a rechargeable battery. The power source 226 may be removed and charged at desired intervals. According to an embodiment of the invention, the active venting system may include a second filter (not shown).

The blower 228 is turned on or off by the electronic device or the printed circuit board 224 to vent the exhaled air. The electronic device or the printed circuit board 224 triggers suitable control signals for the blower 228 to regulate the speed and amount of airflow. According to an embodiment of the invention, the active venting system 108 remains turned on throughout the period of use. The active venting system 108 may be turned off manually after use.

According to an embodiment of the invention, the power source 226 is a detachable and chargeable power source.

In one embodiment the power source 226 is supplied by means of an electrical wire or cable to the electrical mains. In another embodiment the power source 226 recharged via a Universal Serial Bus (USB) micro cable to power bank whilst the active venting system is still operating.

In an embodiment, the blower 228 may be a micro blower or a micro fan providing for example, 0-25 L/min of airflow. The blower 228 allows active air exchange within the respirator body 102 during an exhalation cycle. The sensor 230 may be for example, a piezoelectric sensor and embedded on the inner surface of the respirator body 102 in front of the nose or mouth to sense exhaled air during each breathing cycle. The sensor 230 in turn communicates with the electronic device 224 to control the operation of the blower 228. Thereafter, the blower 228 effectively vents the respirator body 102 during each breathing cycle. In case sensor 230 is not present, the blower 228 is left on permanently.

It should be noted that the blower 228 in the active venting system 108 can be a range of different micro-fans, both of axial and centrifugal type. In one embodiment the blower 228 is an axial type micro-fan that sucks air from one direction and vents in another direction along the axis of the fan. Another embodiment of the present invention uses a centrifugal type micro-fan. One another embodiment use blower type centrifugal micro-fans. Both centrifugal micro-fan and blower type centrifugal micro-fans sucks air from one (or multiple) direction, and vents air through another direction(s).

In an embodiment, the blower 228 may create a forced ventilation to vent excess heat and humidity from the blower outlet 232 in each breathing cycle. Also, the opening 234 for blower egress may vent the exhaled air from the respirator body 102. Further, the exhaled air can be filtered before exiting from the respirator body 102 through the optional filter. It should be noted that the blower 228 vents the air expelled by the user which is a carbon-di-oxide gas along with heat and moisture.

The invention substantially improves user's breathing comfort over long periods. The sensor 230 driven blower 228 is energy efficient and consumes significantly less power than conventional systems. In addition, the respiratory device 100 is lightweight, compact and portable due to the use of a micro blower/fan. The invention is an ideal solution for users who stay in a hostile environment with air pollution or contamination for a prolonged period of time.

FIG. 6 depicts the functioning of the respiratory device 100 during an exhalation phase. Due to the angled positioning of the air guide 106, the exhaled air concentrates in a region surrounded by the air guide 106. The air guide 106 channels the exhaled air from the nostrils in this region and a hot air zone 136 is established inside the respirator body 102. The sensor 230 depicted in FIG. 5, senses the exhaled air due to which the electronic device 224 activates the blower 228. The blower 228 then vents the exhaled air to the atmosphere as depicted by the arrow 138.

It should be noted that most of the exhaled air is vented through the active venting system 108. However, some of the exhaled air may escape from the gaps 112 as depicted by arrows 140. The gaps 112 allow excess exhaled air to escape to the sides of the respirator body 102 when the speed of the active venting system 108 is not enough to vent the exhaled air completely.

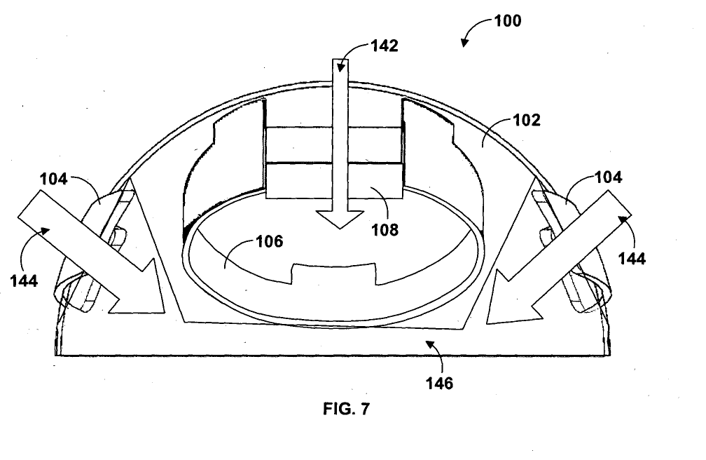

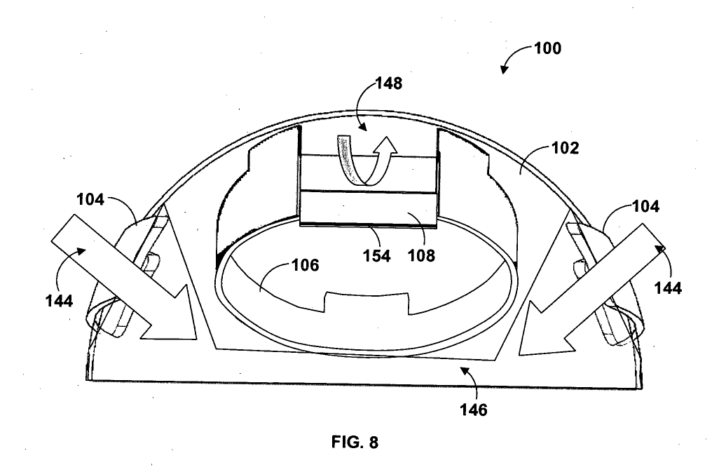

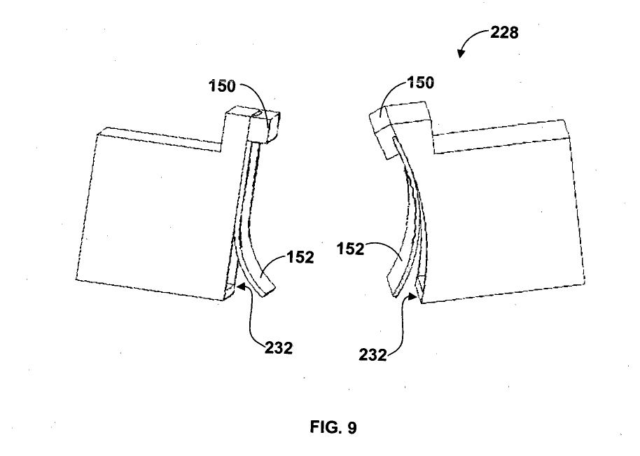

During inhalation, as shown in FIG. 7, through the filter 104, clean air enters the respirator body 102 depicted by airflow 144. This creates a cool air zone 146 inside the respirator body 102. Mostly, during inhalation, air does not enter through the blower outlet 232 as the blower 228 operates to vent out air, thereby preventing dust particles from entering through the blower outlet 232 anyway. However, in an optional embodiment, in order to prevent external dust particles from entering the respirator body 102 through the blower outlet 232 (depicted in FIG. 5) as depicted by airflow 142, a filter or a one-way valve may be used as described in FIGS. 8-9.

FIG. 8 depicts the embodiment wherein a second filter 154 is placed across a blower suction inlet. When air is being sucked through the blower outlet 232 in the reverse direction 148 during inhalation, particles are arrested by the second filter 154, and prevented from entering the respirator body 102. This embodiment has the additional advantage of minimizing humid air inside the respirator body 102 from being sucked into a blower motor and degrading the electronic device 224 during exhalation. It should be noted that the second filter 154 can be attached either to the blower inlet or outlet without limitation

In case the second filter 154 is not used, the blower expels air even during inhalation. Therefore, ambient air does not enter into the respirator body 102 as the blower continuously expels the air.

FIG. 9 shows a second embodiment that implements one way control valve, using a membrane 152. The membrane 152 allows air to flow out through the blower outlet 232, but prevents air from entering in the reverse direction. The membrane 152 is attached to the blower outlet 232 by utilizing a fastener 150. It is understood that a variety of mechanical means allow the membrane to be held over the blower outlet 232. It should be noted that the one way control valve with a membrane can be attached either to the blower inlet or outlet without limitation.

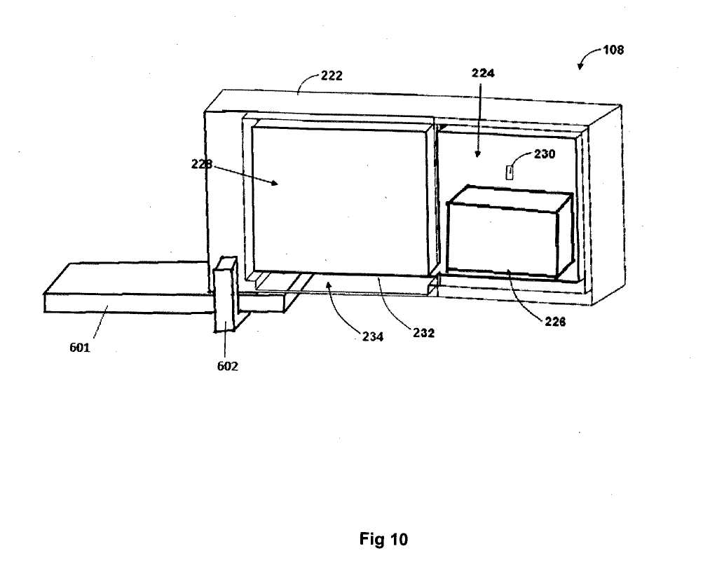

FIG. 10 shows another embodiment wherein the active venting system 108 is attached to a latch 160 with help of a latch holder 161 to prevent the ambient air from entering the respirator body 102. The latch 160 is embedded with a sensor that automatically closes when the power of the active venting system 108 runs out. Also if required the user can manually operate the latch 160 to close to block the blower opening. It should be noted that the latch 160 can be attached either to the blower inlet or outlet without limitation.

From the above, it should be noted that the air guide 106, positioned at the bottom of the respirator body 102, along with the active venting system 108 creates a dedicated pathway for exhaled air to be effectively vented from the respirator body 102. In fact, dedicated pathways are formed due to the described positioning of the filters 104, air guide 106 and active venting system 108. Inhaled air flows through a region separate from the exhaled air and does not mix with the exhaled air forming separate air zones.

Further, the active venting system 108 can be adapted and attached onto any respirators or protective gears. The respirator body may be used, for example, a disposable N95 respirator. In the respirator body of N95 respirator, an opening can be cut and the active venting system 108 can be attached to it. Similarly, the active venting system 108 can be fit onto the respirator body 102 of other respirators (disposable or non-disposable alike). The disposable respirators can be for example the silicon/rubber ones, full-face or half-face, with filters or canisters, etc without limitation.

Through the above description, one can understand that this respiratory device with active venting system and internal air guide can provide the wearer with filtered purified air, discharge exhaled air and vent the respirator body in every breathing cycle. All these features will provide users with an improved breathe experience due to the active air exchange within the respirator body.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

Although embodiments of the current disclosure have been described comprehensively, in considerable detail to cover the possible aspects, those skilled in the art would recognize that other versions of the disclosure are also possible.

1. An active venting system for venting air from a device covering mouth and nose, said active venting system comprises:
a power source;
a blower coupled to the power source; and
an electronic device or a printed circuit board coupled to the blower,
wherein the blower is turned on or off by the electronic device or printed circuit board to vent exhaled or dead air from the respirator body.

2. The active venting system of claim 1, wherein the blower is a micro-fan.

3. The active venting system of claim 1, wherein the electronic device or the printed circuit board triggers suitable control signals for the blower to regulate the speed and amount of airflow.

4. (canceled)

5. (canceled)

6. The active venting system of claim 1, wherein the power source is a detachable and chargeable power source.

7. (canceled)

8. The active venting system of claim 1, wherein the power source can be recharged via a USB-micro cable to a power bank while the active venting system is still operating.

9. The active venting system as claimed in claim 1, wherein the devices are units coverings face and mouth such as protective gears and respiratory devices.

10. (canceled)

11. A respiratory device comprising:
a respirator body which covers face and mouth of a wearer to form a relatively closed area sealed from ambient air;
at least one first filter integrally disposed in the respirator body for filtering inhaled air; and
at least one active venting system functionally coupled to the respirator body wherein the active venting system operates to vent air from the respirator body,
wherein the active venting system comprises:
a power source;
a blower coupled to the power source; and
an electronic device or a printed circuit board coupled to the blower,
wherein the blower is turned on or off by the electronic device or printed circuit board to vent exhaled air from the respirator body.

12. The respiratory device of claim 11, further comprising at least one air guide positioned at a one air guide positioned around the active venting system and surrounding the nose and mouth region of wearer to channel and separate exhaled air and inhaled air.

13. The respiratory device of claim 12, wherein the air guide is positioned at an angle inclined with respect to an ergonomic facial profile to remove excess exhaled air; or the air guide is positioned so that at least one gap exists between the air guide and the base of the respirator body to allow excess exhaled air to escape in case the excess exhaled air is not vented through the active venting system.

14. (canceled)

15. The respiratory device of claim 11, wherein the active venting system is attached to a one way control valve with a membrane to prevent ambient air from entering through the blower inlet or outlet into the respirator body at all times; or the active venting system is attached to a second filter to prevent ambient air from entering the respirator body.

16. The respiratory device of claim 15, wherein the one way control valve with the membrane or the second filter is attached either to an inlet or outlet of the blower.

17. (canceled)

18. (canceled)

19. The respiratory device of claim 11, wherein inlet or outlet of the blower is attached to a latch to prevent ambient air from entering the respirator body.

20. (canceled)

21. The respiratory device of claim 19, wherein the latch is embedded with a sensor that automatically closes when the power of the active venting system runs out; or the latch is manually closed by user to block the blower opening.

22. (canceled)

23. The respiratory device of claim 12, wherein the respirator body, the active venting system and the air guide are together collapsible into a pocket size.

24. The respiratory device of claim 12, wherein the respirator body is any of the following: an air filtering respirator; an air purifying respirator; a disposable or reusable mask; a non-disposable mask; or an escape hood.

25.-28. (canceled)
